(19) United States
(12) Patent Application Publication
(10) Pub. No.: US 2009/0022859 A1
(43) Pub. Date: Jan. 22, 2009

(54) Container assembly

(76) Inventor: Winston Foster, Middlesex (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/920,179

(22) PCT Filed: May 11, 2006
(86) PCT No.: PCT/GB2006/001746

§ 371 Date: Mar. 24, 2008

(30) Foreign Application Priority Data
May 11, 2005 (GB) 0509571.6

(51) Int. Cl. B65D 85/00; A23L 3/36

(52) U.S. Cl. 426/115; 426/524

(57) ABSTRACT

The invention relates to a container assembly comprising fluid, and particularly beverage, cooling and/or mixing means. The cooling and/or mixing is achieved by positioning a movable plunger assembly within the container, the base of which defines notional volume variable upper and lower chambers of the container. The base of the plunger is provided with perforations (and optionally, sealable compartments for sugar, milk etc.) adapted to allow pressurised liquid to be urged from the lower chamber to form upwardly directed jets of liquid in the upper chamber. The invention is particularly advantageous because it allows the consumer to selectively cool and/or mix a beverage by means of a plunging and/or twisting action, thus balancing the demand for hot beverages with the dangers of scalding.

The present invention relates to a container assembly and particularly, but not exclusively, to a beverage container assembly comprising fluid cooling and/or mixing means.

It is well known that various beverages, for example, coffee, tea and hot chocolate must be served hot to satisfy the customer. In particular, coffee is often served at a very high temperature in order to release the rich flavour from the coffee beans. Moreover, it is often preferred that hot beverages are served at a higher initial temperature so that they may be consumed over a longer period of time before cooling to an unacceptably low temperature.

However, the demand for very high serving temperatures for certain beverages must be balanced against the risks of scalding a person's mouth whilst drinking, or a person's body if the drink is spilled. The likelihood of spillage is significantly increased where a person is carrying a beverage container whilst on the move, e.g. walking, driving or using crowded public transport.

In an attempt to accelerate the cooling of a hot beverage to an acceptable temperature for immediate consumption, a person may remove the lid, if any, from a container and blow on the surface of the liquid. The action of removing a lid in itself may disturb the beverage and cause it to spill from the container. Moreover, the blowing action may agitate the liquid to such an extent that some of it is expelled from the container onto a person's face or hand.

Beverages which are already served cool can be cooled further by the addition of ice. Further cooling of the beverage can be accelerated by mixing the beverage and ice within the container. Similarly, if cream, milk, sugar etc. are to be added to a beverage this will involve removal of the lid and stirring of the contents. In both circumstances, the aforementioned problems may be encountered.

According to a first aspect of the present invention there is provided a beverage container assembly comprising a container having a reciprocally moveable plunger locatable therein, said plunger having a perforated base member and an actuating member, the base member defining notional volume-variable upper and lower chambers of the container; wherein the perforations are spaced apart and adapted to allow a pressurised beverage to be urged from the lower chamber through the perforations to form upwardly directed jets of liquid in the upper chamber during operation of the plunger, characterised in that the actuating member defines an exit passage for said beverage.

According to a second aspect of the present invention there is provided a container lid and plunger assembly comprising a plunger having a perforated base member and an actuating member extending from the base member, the perforations being spaced apart such that jets of a pressurised beverage can be urged through the perforations during operation of the plunger, and wherein the actuating member is coupled to a lid, characterised in that the actuating member defines an exit passage for said beverage.

According to a third aspect of the present invention there is provided a method of cooling a liquid held within a container using the apparatus of the first aspect, said method comprising the steps of:
(i) introducing the plunger into the container;
(ii) applying a downward force to the plunger such that its perforated base member pressurises the liquid and urges a portion thereof through the perforations; and
(iii) if required, applying an upward force to the plunger to return it to a position above the surface of the liquid.

According to a fourth aspect of the present invention there is provided a method of cooling a liquid held within a container using the apparatus of the second aspect, said method comprising the steps of:
(i) closing the opening of a container by means of a container lid and plunger assembly;
(ii) applying a downward force to the plunger such that its perforated base member pressurises the liquid and urges a portion thereof through the perforations; and
(iii) if required, applying an upward force to the plunger to return it to a position above the surface of the liquid.

Embodiments of the present invention will now be described, by way of example only, with reference to the accompanying drawings in which:—

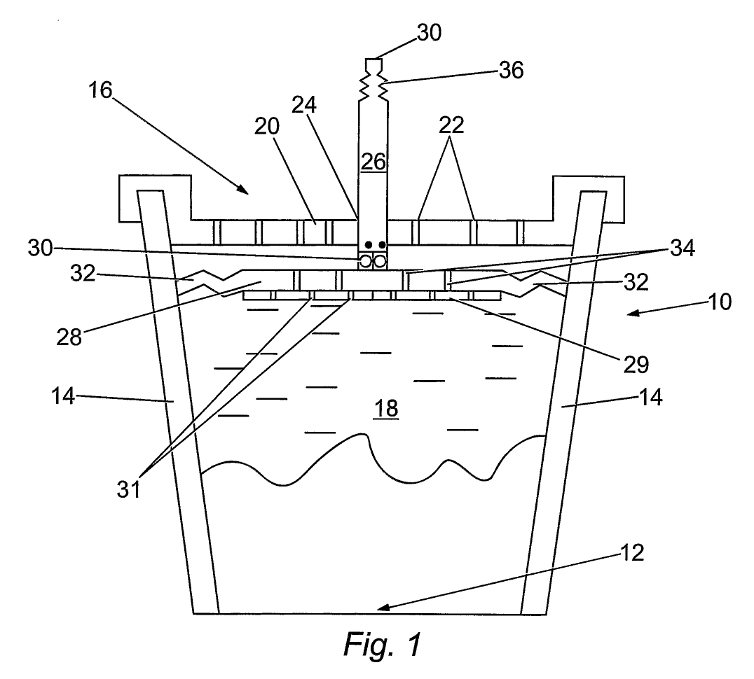

FIG. 1 is a partial cross-sectional view of a container assembly according to the present invention;

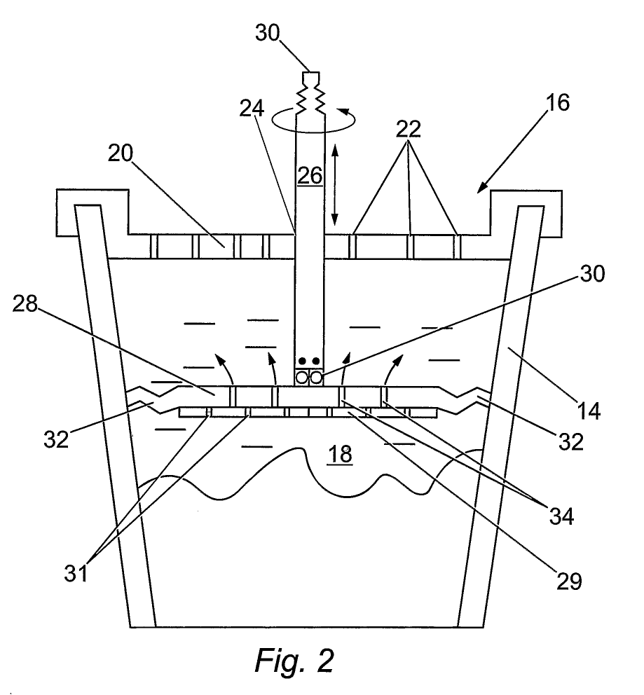

FIG. 2 is a cross-sectional view of the container assembly of FIG. 1 in use showing the plunging and rotation directions;

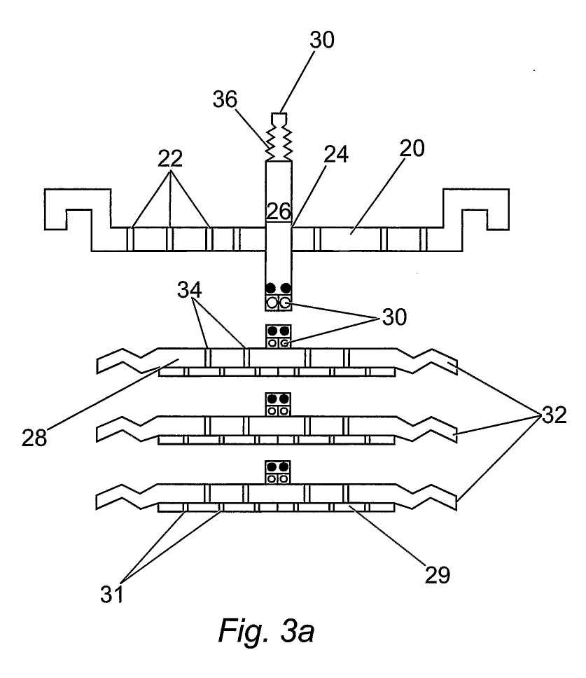

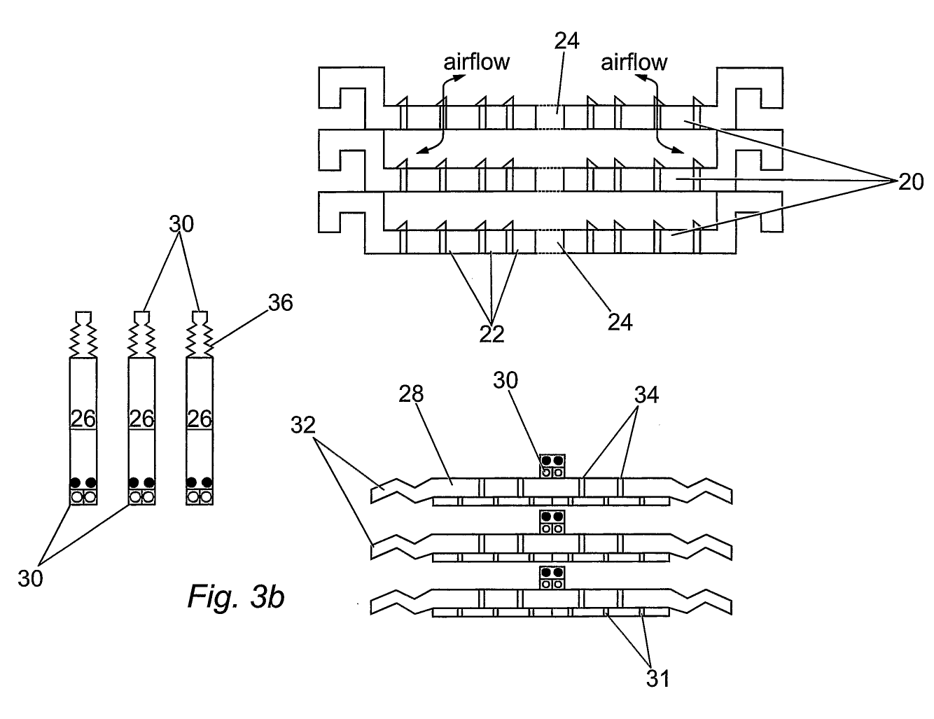

FIG. 3a is a cross-sectional view of an actuating member coupled to a lid ready for connection to the uppermost of three stackable base members;

FIG. 3b shows cross-sectional views of the components of the plunger mechanism before assembly;

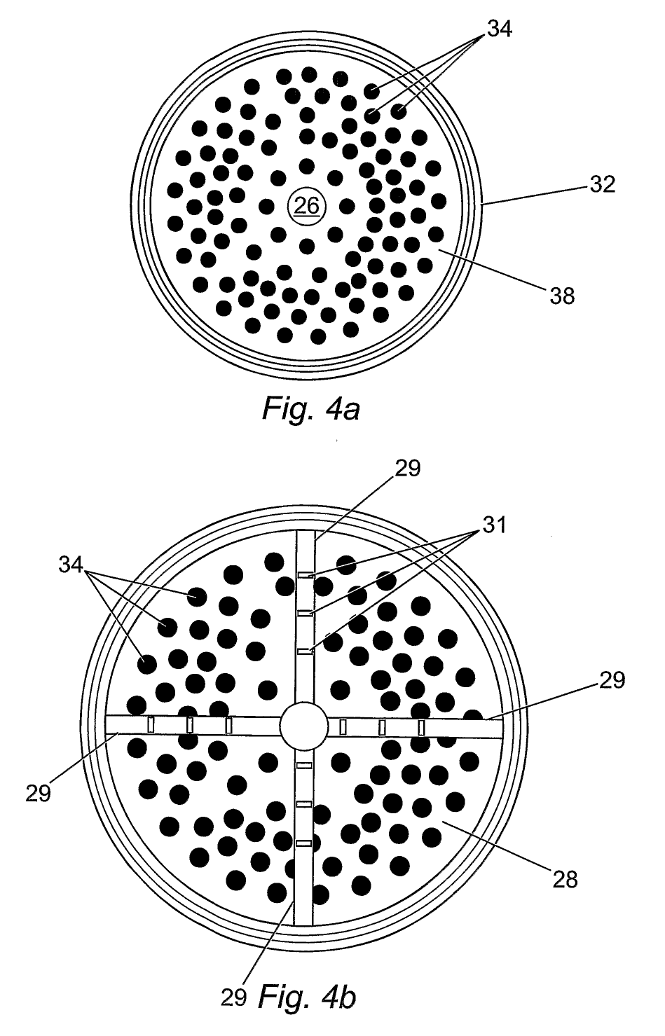

FIG. 4a is plan view of a base member without the paddle members;

FIG. 4b is plan view of a base member with paddle members;

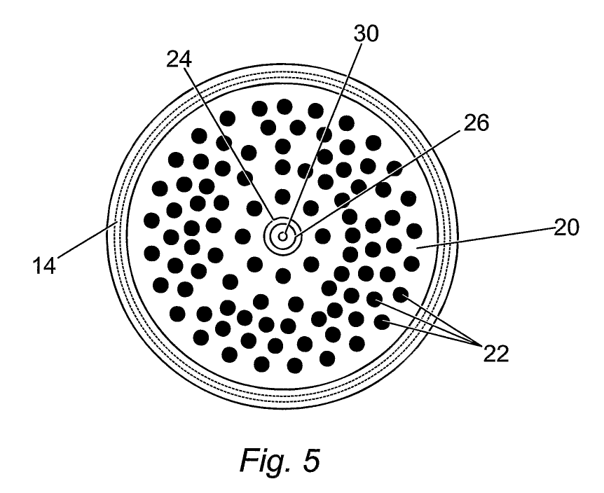

FIG. 5 is a plan view of a container of the present invention closed with a lid;

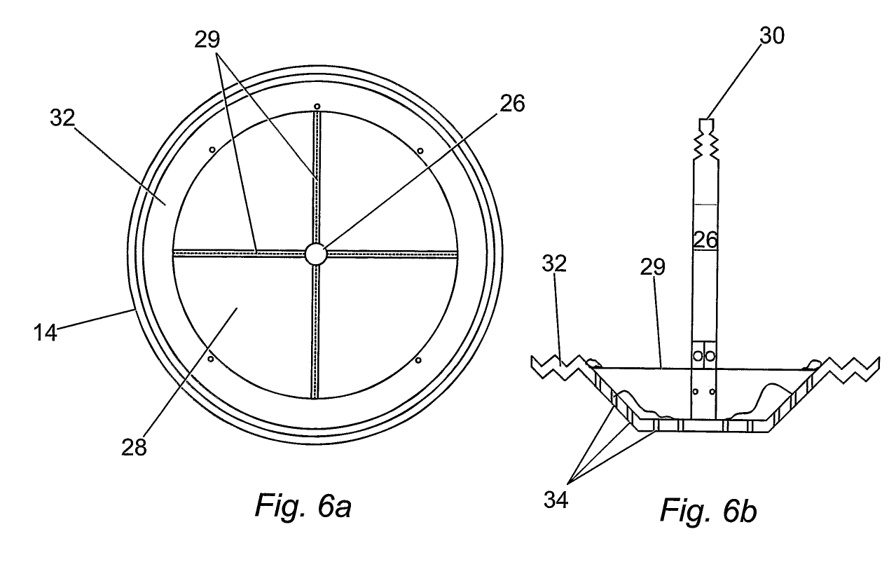

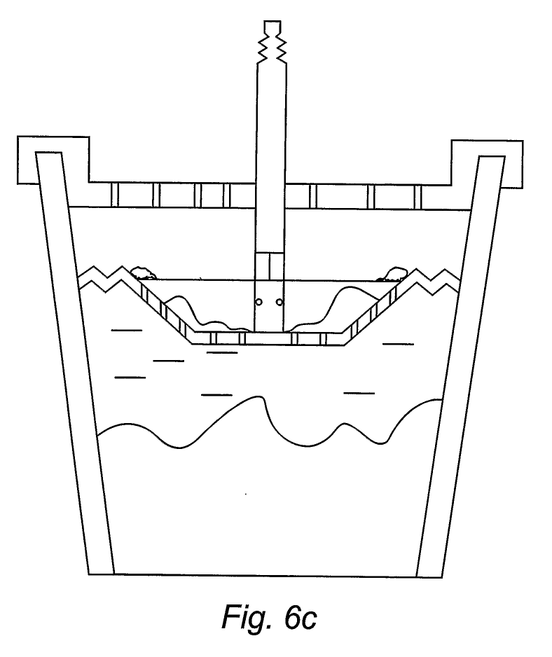

FIG. 6a is a plan view of a plunger mechanism positioned within a container;

FIG. 6b is a cross-sectional view of the modified plunger of FIG. 6a showing foodstuffs housed within compartments on the base member;

FIG. 6c is a partial cross-sectional view of the plunger of FIG. 6a within the container and coupled to a lid; and

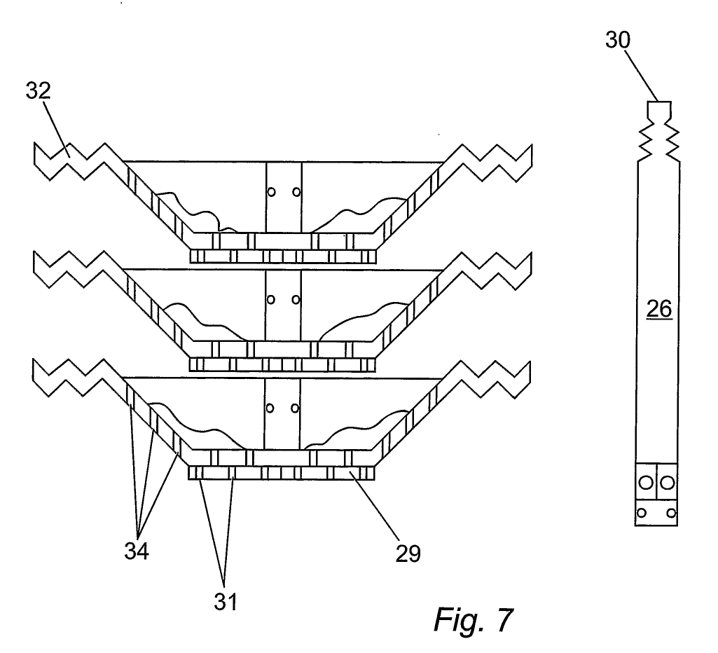

FIG. 7 is a cross-sectional view of three stacked modified base members having paddle members on their lower surfaces.

FIGS. 1 and 2 show a beverage container 10 having a base 12, side wall(s) 14 and an opening 16. The container 10 is formed from a plastics material and is filled with a hot liquid 18. The opening 16 of the container is closed by a lid and plunger assembly. The lid 20 (also shown in FIG. 5) is sealed around the rim of the opening 16 in a conventional manner. The lid has a series of air-circulation perforations 22 to allow air to circulate freely between the interior and exterior of the container 10. An aperture 24 is formed in the centre of the lid 20 and is positioned to correspond with, and dimensioned to receive, an actuating member 26 of the plunger. The actuating member 26 extends through the aperture 24 to the exterior of the container 10 and contact with the lid 20 is maintained by means of a friction fit.

The actuating member 26 is in the form of a hollow tube and is connected at its lower distal end to a substantially central region on the upper surface of a base member 28 of the plunger. Openings 30 are provided at both the upper and lower distal ends of the actuating member 26 and it will therefore be appreciated that the actuating member 26 provides the dual function of an actuating means for the plunger and a drinking spout or straw to allow the user to consume the liquid 18 within the container 10. The openings 30 at the lower distal end of the actuating member 26 are located above the top surface of the base member 28 for reasons described further below. The lower openings 30 are distributed evenly around the circumference of the actuating member 26. The actuating member 26 is provided with length adjusting means in the form of a collapsible concertina region 36. In the FIGS. the concertina region is shown in a substantially collapsed state.

The base member 28 (also shown in FIG. 4b) is in the form of a disc, its surface plane being perpendicular to the central longitudinal axis of the actuating member 26. The actuating member 26 and the base member 28 are preferably formed from a plastics material having suitable strength and temperature resistance characteristics. The outer circumference of base member 28 is provided with a resilient seal 32 to provide a sealing engagement with the inner wall 14 of the container 10. The seal 32 is sufficiently resilient to maintain its sealing engagement at all positions within the inner wall 14 of the container 10 that tapers inwardly from its opening 16 to its base 12. It should be noted that the resilient seal 32 is an optional feature serving primarily to promote the creation of thin jets of hot liquid which are propelled above the liquid's surface.

The base member 28 is further provided with perforations 34 that allow passage of both air and the liquid 18. The number and cross-sectional area of the perforations are selected to accelerate cooling of a pressurised liquid forced through the perforations from the lower chamber (i.e. the notional and variable volume below the base member 28) to the upper chamber (i.e. the notional and variable volume above the base member 28) during operation of the plunger. Accordingly, the number and cross-sectional area of the perforations may be selected depending upon the size of the container and/or the nature, e.g. the viscosity, of the hot liquid 18.

The base member 28 is provided with four elongate paddle arms 29 on its underside. The paddle arms 29 are equi-spaced and extend radially from the centre of the base member 28 (as shown in FIG. 4b). The paddle arms 29 are provided with perforations 31 which extend width-wise through the arms 29. The perforations 31 are therefore arranged perpendicularly with respect to the perforations 34 on the disc of the base member 28.

Before use, a number of lid and plunger assemblies may be conveniently stacked one on top of the other as illustrated in FIGS. 3a and 3b. As is apparent from these figures, the actuating members 26 are releasably connectable to the base members 28 by any suitable means, for example, a bayonet fitting. Disconnection of the lid and plunger assembly into separate lid, actuating member and base member components facilitates stacking of the respective components for storage, transit and dispensing purposes.

In use, the beverage container 10 may be filled with a liquid 18 such as boiling water, tea, coffee, hot chocolate etc. Alternatively, the-beverage container may be filled with a cold drink. The opening 16 of the container is then closed by placing the lid/plunger assembly over the opening 16 and sealing the lid 20 around the rim of the container 10 in a conventional manner. Depending upon the level of the liquid 18 within the container 10, as the lid 20 is positioned on the rim of the container 10, the perforated base member 28 of the plunger will either rest on the top surface of the liquid 18 or be suspended above the liquid 18. In order to drink the liquid 18 via the drinking spout/straw, the user must manually push the drinking spout/straw 26 downwards until its opening(s) 30 near its base are submerged beneath the surface of the liquid 18. To enable the user to push the lower openings 30 of the spout/straw 26 to the bottom of the container 10, the user may first need to expand the collapsible region 36 of the drinking spout/straw 26.

If the user wishes to cool or mix the liquid 18, the drinking spout/straw 26 is moved manually back and forth in a reciprocal manner to thus move the base member 28 of the plunger into and out of the liquid 18. In view of the fact that the liquid 18 is substantially incompressible, the downward motion of the plunger into the liquid 18 pressurises the liquid and urges a portion thereof through the perforations 34 in the base member 28. Accordingly, the volume of liquid 18 displaced from the notional lower chamber to the notional upper chamber corresponds with the distance through which the plunger travels during its downward motion. In view of the pressurised nature of the liquid 18, it is ejected from the perforations 34 in a series of spaced apart upwardly directed thin jets as shown in FIG. 2. The jets may be in the form of fast or slow moving streams of moving liquid depending upon the applied plunging force and/or the cross-sectional area of the perforations. It will be appreciated that the presence of the resilient seal 32 on the base member will act to maximise the pressurisation of the liquid and create more powerful thin jets of liquid.

Cooling of the liquid within the container can be effected in number of ways. For example, if the thin jets are propelled completely out of the body of the liquid or at least above its surface, this will cause an increase in the surface area of ejected hot liquid 18 and therefore accelerate its cooling. Heated air in the upper chamber can escape from the container via convection (or due to the increase in pressure in the upper chamber caused by the upward motion of the base member 28) through the air-circulation perforations 22 in the lid 20. The air-circulation perforations 22 are offset horizontally with respect to the perforations 34 in the base member 28 to prevent propelled hot liquid 18 escaping from the container 10.

The law of fluid dynamics, and in particular Newton's Law of Cooling, dictates that cooling of a liquid below its surface can be accelerated by the plunging action described above. Newton's Law of Cooling says that the rate of change of the difference in temperature is dependent on the actual difference in temperature (i.e. the liquid temperature and ambient temperature). In other words, as a hot beverage cools down closer to the ambient temperature, the rate of cooling slows. Typically, a beverage within a container will cool down most at the liquid's surface and the walls of the container. The majority of the liquid at the centre of the container will only cool if its heat energy is conducted to the walls of the container or the liquid.

Agitation of the beverage will accelerate its cooling because the effective surface area of its contact with the container's walls and its exposure at the liquid surface will be increased. Temperature gradients within the beverage will also induce convection currents acting to transfer heat in the direction of the temperature gradient.

In order to progressively cool the hot liquid 18 to the desired temperature, the reciprocal motion of the plunger may need to be repeated several times.

The spacing, size and number of the perforations 34 in the base member is therefore optimised to balance their dual roles of creating jets of liquid 18 (during downward motion of the plunger) and allowing cooled liquid 18 to drain back into the notional lower chamber (during the upward motion of the plunger).

In addition, the paddle arms 29 provide added structural support to the base member 28 and facilitate mixing of the liquid within the notional lower chamber of the container. Mixing of the liquid is effected by manual rotation of the drinking spout/straw 26 as indicated by the arrow in FIG. 2. It will be appreciated that the perforations 31 allow passage of liquid during rotation of the paddle arms 29 and thus reduce the rotational force required and promote thorough mixing of the liquid.

A user can drink from the container 10 by means of the drinking spout/straw 26. In order to do so, the lower openings 30 of the spout/straw 26 must be submerged beneath the surface of the liquid 18. Once submerged, the drinking spout/straw 26 is maintained in position due to the frictional engagement of the seal 32 against the inner wall 14 of the container 10. Accordingly, measured quantities of liquid can be consumed by pushing the drinking spout/straw 26 downwards in incremental stages. Cooling of the liquid 18 will be accelerated most near its surface because this is where the thin jets of liquid created by the plunger are most likely to be propelled above the liquid's surface. Accordingly, the advantage of pushing the drinking spout/straw 26 downwards in incremental stages and consuming the contents of the container 10 in several portions can be readily appreciated. A smaller volume of liquid 18 forced into the notional upper chamber will be cooled more quickly than a larger volume of liquid. The reason for this is that a higher proportion of a smaller volume of liquid will have been ejected through the perforations 34 in the form of thin jets having a high surface area. It will be appreciated therefore that the user has a degree of control over the temperature of the liquid in the upper chamber both by means of repeating the reciprocal plunging action and by selection of an appropriate volume of liquid 18 forced into the upper chamber.

Alternatively, a user may opt to immediately push the drinking spout/straw 26 to the bottom of the container 10. This allows all of the container's contents to be consumed with substantially no cooling and without the need for incremental pushing of the spout/straw 26. This method may be used if the user prefers to consume the liquid 18 at a higher temperature and/or allow it to cool naturally over a longer period of time.

It will be appreciated that the features of the present invention provides a simple and convenient solution to the problem of quickly cooling hot beverages to the preferred drinking temperature. In particular, the invention obviates the need for a user to blow on the surface of the liquid or remove a container's lid to stir, both of which increase the risk of spillage or scalding of the hand or mouth. Instead, the invention allows the user to control the rate of cooling according to their specific needs or preferences.

Moreover, the plunger assembly of the present invention serve to provide an improved structural integrity to the wall(s) of a beverage container which is/are often flimsy.

In an alternative embodiment (not shown), the invention may be used to promote further cooling of beverages such as soft drinks that are already served cool, i.e. soft drinks, by mixing them with ice. Further cooling is promoted by mixing of the ice within the beverage to accelerate the melting of the ice. This can be achieved by rotation of the actuation member as shown in FIG. 2. Alternatively, the base member 28 may be modified for use only with cool liquids. For example, the base member may be reduced in size such that it does not contact the side walls 14 of the container. The modified base member may comprise paddle members or other surface textures to promote effective mixing of a beverage and would be prevented from floating out of the container due to the frictional engagement with the aperture 24 formed in the lid 20.

In a further alternative embodiment (shown in FIGS. 6a-c and 7), the invention may be used to separate combinations of liquids and solids until such time as they require to be mixed. For example, tea/sugar/milk/coffee/cream etc could be provided in powdered form and sealable compartments are provided on the upper surface of the base member 28 to hold such dissolvable foodstuffs. The sealable compartments are defined by the paddle members 29 provided on the upper surface of the base member 28.

In use, the seals (i.e. one or two sugar compartments depending upon user preference) would be selectively removed or broken as the lid/plunger assembly is coupled to the container. It will be appreciated that the perforations 34 necessitate that seals are provided both on the upper and lowers surfaces of the base member 28. Only one of the seals need be broken to allow the foodstuffs within the compartments to be mixed with the liquid. However, in order that the apparatus of the invention can be used to its full potential as both a mixing and cooling device, the upper and lower seals must be broken to allow the perforations 34 to perform their function of creating thin jets of liquid upon plunging.

Mixing of the appropriate ingredients with the hot liquid would occur only when the base member 28 is submerged under the surface of the liquid. Mixing could be effected by rotating the base member 28 shown in FIG. 6, or the modified base member 28 having paddle arms 29 provided on the lower surface of the base member 28, as shown in FIG. 7. It will be appreciated that such an arrangement would represent a particularly efficient means of mixing and/or cooling beverages.

Modifications and improvements can be made without departing from the scope of the present invention. For example, the containers, lids, base members etc could be formed in a variety of designs, shapes and sizes. Temperature indicia could be provided on the exterior surface(s) of the lid, actuating member or container to assist the user in determining the extent of cooling of the liquid.

The base members and sealable compartments may be formed such that only one seal need be broken whilst still allowing the creation of thin jets of liquid upon plunging. For example, a series of perforations may be formed around the perimeter of the base member, outside the boundaries of the compartments.

Although the embodiments described above relate to disposable beverage containers, the invention could equally be applied to re-usable beverage containers, for example, flasks. Indeed, the invention need not be limited to the cooling of beverages. Moreover, it is envisaged that the invention could be adapted for use in industrial applications which require separation and selective mixing/cooling of liquids and/or solids.

Although the invention has been described with reference to small hand-held beverage containers having manually operated plungers, it could equally be adapted to operate on a larger scale with the plunging action being automated.

The length adjusting means of the actuating arm of the plunger may be a telescopic arrangement rather than, or in addition to, a collapsible concertina arrangement. Different arrangements of the paddle members 29 are possible.

It will be appreciated that the container may be formed from any suitable material having appropriate strength and temperature resistance characteristics. Conventionally, hot drinks are served in insulated plastics or foamed plastics containers made from polypropylene or polystyrene. Cooling of the hot liquid could be further accelerated by opting for a more conductive material or other means of promoting cooling by radiation. However, this would need to be balanced against the discomfort of holding a hot container.

1. A beverage container assembly comprising a container having a reciprocally moveable plunger locatable therein, said plunger having a perforated base member and an actuating member, the base member defining notional volume-variable upper and lower chambers of the container; wherein the perforations are spaced apart and adapted to allow a pressurised beverage to be urged from the lower chamber through the perforations to form upwardly directed jets of liquid in the upper chamber during operation of the plunger, characterised in that the actuating member defines an exit passage for said beverage.

2. A container assembly according to claim 1, wherein the perforated base member is adapted to sealingly engage the perimeter of the inner wall of the container.

3. A container assembly according to claim 1, wherein one or more paddle arms are provided on an upper and/or lower surface of the base member.

4. A container assembly according to claim 3, wherein the or each paddle arm is provided with perforations that extend width-wise and perpendicularly with respect the base member's perforations.

5. A container assembly according to claim 1, wherein one or more sealable compartments are provided on the base member for holding foodstuffs for selective mixing and/or dissolving within the liquid.

6. A container assembly according to claim 1, wherein the actuating member is removably connectable to the base member.

7. A container assembly according to claim 6, wherein the actuating member is removably connectable to the base member by means of a bayonet connection.

8. A container assembly according to claim 1, wherein a length adjusting means is provided on the actuating member.

9. A container assembly according to claim 8, wherein the length adjusting means is defined by a collapsible region of the actuating member.

10. A container assembly according to claim 8, wherein the length adjusting means is defined by a telescopic region of the actuating member.

11. A container assembly according to claim 1, wherein the actuating member is in the form of a drinking spout or straw.

12. A container assembly according to claim 1, wherein one or more apertures are provided proximate the lower distal end of the actuating member above the base member.

13. A container assembly according to claim 1, wherein the container is provided with a releasable lid having air-circulation perforations.

14. A container assembly according to claim 13, wherein the air-circulation perforations are offset horizontally from the perforations in the base member.

15. A container assembly according to claim 13, wherein an aperture is provided in the lid and positioned to correspond with, and receive, the actuating member.

16. A container lid and plunger assembly comprising a plunger having a perforated base member and an actuating member extending from the base member, the perforations being spaced apart such that jets of a pressurised beverage can be urged through the perforations during operation of the plunger, and wherein the actuating member is coupled to a lid, characterised in that the actuating member defines an exit passage for said beverage.

17. (canceled)

18. (canceled)

19. A method of cooling a liquid held within a container using the apparatus of claim 1, said method comprising the steps of:
(i) introducing the plunger into the container;
(ii) applying a downward force to the plunger such that its perforated base member pressurises the liquid and urges a portion thereof through the perforations; and
(iii) if required, applying an upward force to the plunger to return it to a position above the surface of the liquid.

20. (canceled)

21. A method of cooling a liquid according to claim 17, wherein step (i) is preceded by connecting the actuating member of the plunger to the base member of the plunger.

22. A method of cooling a liquid according to claim 17, wherein step (i) is preceded by the selective removal one or more sealable compartments provided on the base member for holding foodstuffs for selective mixing and/or dissolving within the liquid.

23. A method of cooling a liquid according to claim 17, wherein the beverage is mixed by rotating the plunger.

24. (canceled)

25. A method of cooling a liquid held within a container using the apparatus of claim 16, said method comprising the steps of:
(i) closing the opening of a container by means of a container lid and plunger assembly;
(ii) applying a downward force to the plunger such that its perforated base member pressurises the liquid and urges a portion thereof through the perforations; and
(iii) if required, applying an upward force to the plunger to return it to a position above the surface of the liquid.

26. (canceled)

27. A method of cooling a liquid according to claim 21, wherein step (i) is preceded by connecting the actuating member of the plunger to the base member of the plunger.

28. A method of cooling a liquid according to claim 21, wherein step (i) is preceded by the selective removal of one or more sealable compartments provided on the base member for holding foodstuffs for selective mixing and/or dissolving within the liquid.

29. A method of cooling a liquid according to claim 21, wherein the beverage is mixed by rotating the plunger.

30. A method of cooling a liquid according to claim 21, wherein the plunging and/or rotational forces are applied manually to the plunger.
